(19) United States
(12) Patent Application Publication
(10) Pub. No.: US 2014/0176372 A1
(43) Pub. Date: Jun. 26, 2014

(54) PORTABLE ELECTRONIC DEVICE HAVING NEAR FIELD COMMUNICATION ANTENNA

(71) Applicant: HON HAI PRECISION INDUSTRY CO., LTD., New Taipei (TW)

(72) Inventor: KUANG-YAO LIAO, New Taipei (TW)

(73) Assignee: HON HAI PRECISION INDUSTRY CO., LTD., New Taipei (TW)

(21) Appl. No.: 14/079,639

(22) Filed: Nov. 14, 2013

(30) Foreign Application Priority Data
Dec. 26, 2012 (TW) 101149955

(51) Int. Cl. H01Q 1/22

(52) U.S. Cl. CPC H01Q 1/22; B82Y 15/00
USPC 343/702; 977/953

(57) ABSTRACT

A portable electronic device includes a touch screen and a first PCB. The touch screen includes an effective touch area and an ineffective touch area surrounding the effective touch area. The first PCB is mounted to a rear surface of the touch screen. An NFC antenna and a touch-sensing circuit are arranged around a peripheral area of a front surface of the first PCB and spatially correspond to the ineffective touch area. A transparent shielding layer is arranged on a rear surface of the first PCB and spatially corresponds to the peripheral area of the front surface to shield the NFC antenna from electrostatic interference caused by electrical elements located under the first PCB.

### BACKGROUND

1. Technical Field

The present disclosure relates to a portable electronic device having near field communication (NFC) antenna.

2. Description of Related Art

Nowadays, application using NFC technology is very popular. Portable electronic devices having NFC module can integrate with several different applications, such as bus card, credit card, access card, bank card and membership card, which brings a great convenience to daily life. However, existing NFC antenna usually needs to occupy a larger space of a printed circuit board (PCB) of the electronic device, and adjacent electronic components will interfere with the performance of the NFC antenna. With the popularization of small size portable electronic devices with large display screens and large effective touch area, the design of the NFC antennas and reduction of interference, without increasing the size of the electronic device has been problematic.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1(a) is a schematic diagram showing a front view of a portable electronic device, according to an embodiment; FIG. 1(b) is a schematic diagram showing a side view of the portable electronic device; FIG. 1(c) is a schematic diagram showing a rear view of the portable electronic device.

FIG. 2 is an exploded view of the electronic device of FIG. 1.

FIG. 3(a) is a schematic diagram of a front surface of a first PCB of FIG. 2; FIG. 3(b) is a schematic diagram of a rear surface of the first PCB of FIG. 2.

FIG. 4(a) is a schematic diagram of a front surface of the second PCB of FIG. 2; FIG. 4(b) is a schematic diagram of a rear surface of the second PCB of FIG. 2.

### DETAILED DESCRIPTION

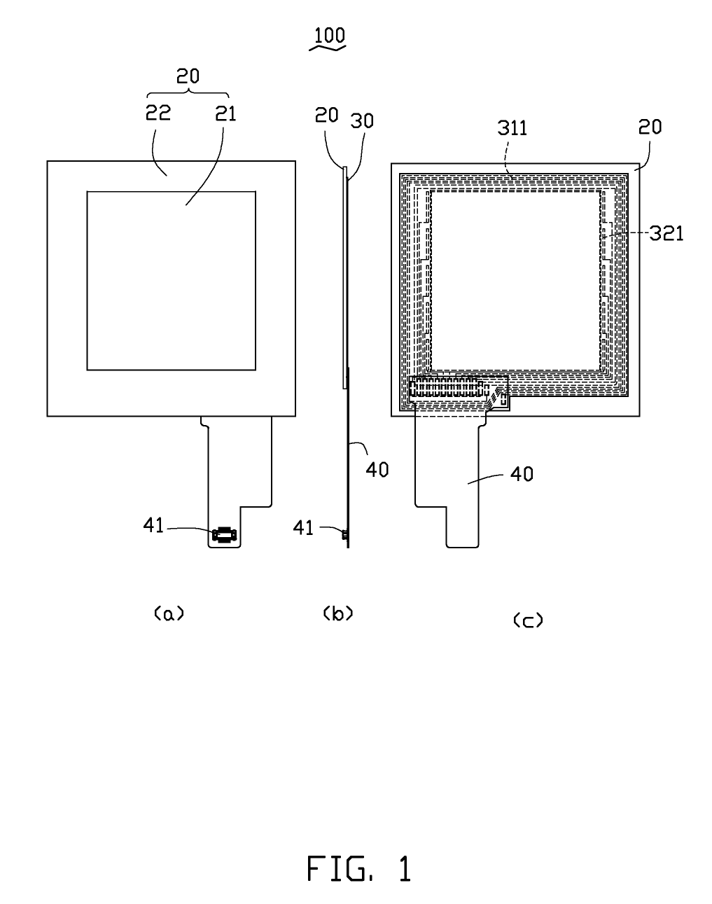

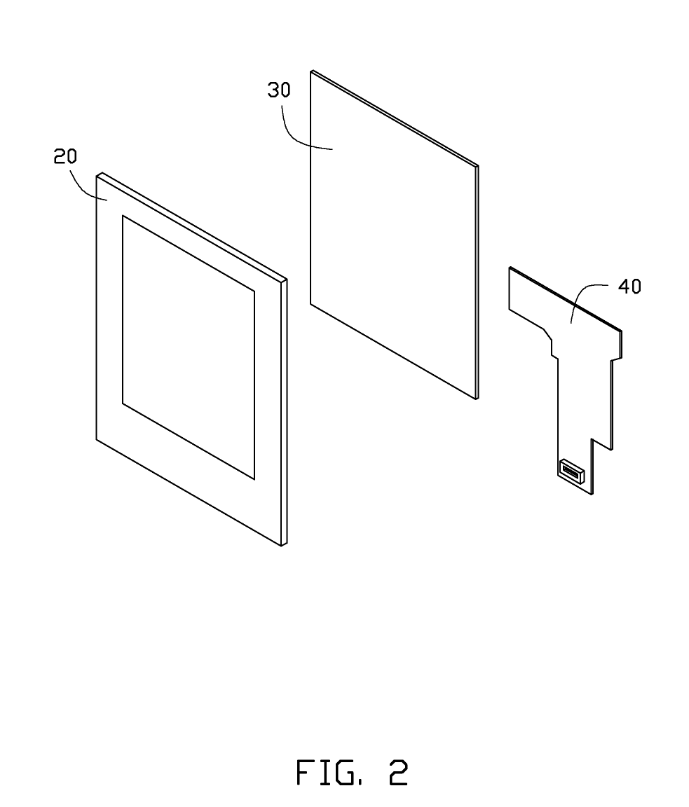

FIGS. 1 and 2 show a portable electronic device 100. The electronic device 100 includes a touch screen 20, a first PCB 30, and a second PCB 40. The electronic device 100 can be a smart phone or an electronic wrist watch, for example. The touch screen 20 includes an effective touch area 21 and an ineffective touch area 22 surrounding the effective touch area 21. The effective touch area 21 is capable of receiving manual touch signals, and the ineffective touch area 22 is incapable of receiving the manual touch signals. The first PCB 30 and the second PCB 40 are arranged on a rear surface of the touch screen 20.

In one embodiment, the first PCB 30 is mounted to the rear surface of the touch screen 20. The first PCB 30 includes an NFC antenna 311 and a touch-sensing circuit 321. The NFC antenna 311 and the touch-sensing circuit 321 are arranged around a peripheral area of the first PCB 30 and spatially correspond to the ineffective touch area 22 of the touch screen 20. The touch screen 20 is made of carbon nanotubes, resulting in reduced electrostatic interference between the touch screen 20 and the NFC antenna 311.

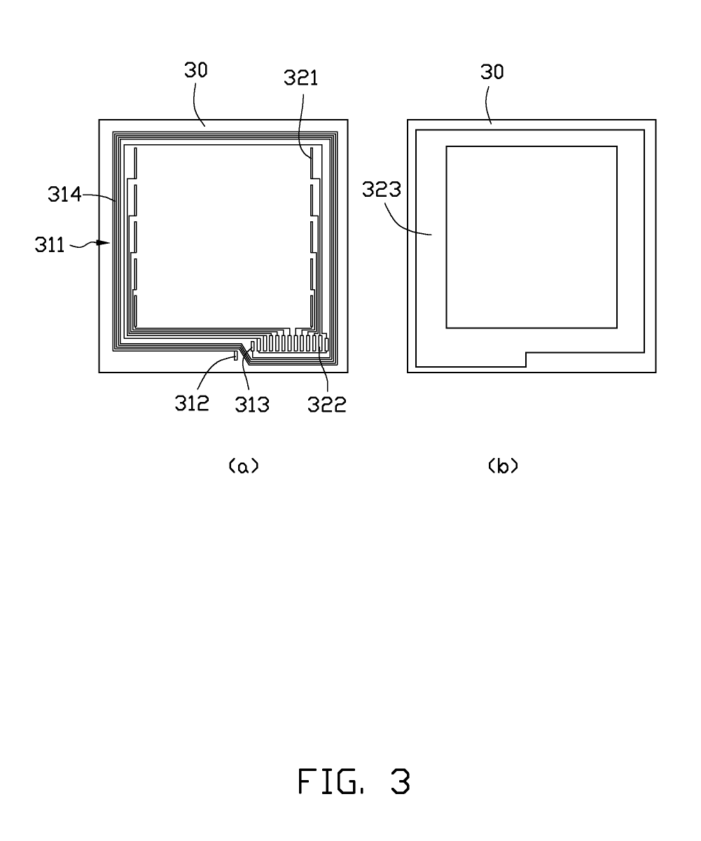

FIG. 3 (a) shows that the NFC antenna 311 and the touch-sensing circuit 321 are arranged side-by-side in a peripheral area of a front surface of the first PCB 30 facing the touch screen 20. In one embodiment, the NFC antenna 311 includes a coil 314, a first antenna connection element 312, and a second antenna connection element 313. The coil 314 surrounds the effective touch area 21 to increase an effective space of the NFC antenna 311 without increasing a size of the electronic device 100 and without reducing a size of the effective touch area 21. The first antenna connection element 312 and the second antenna connection element 313 are connected to two ends of the coil 314, respectively. The touch-sensing circuit 321 surrounds the effective touch area 21. The touch-sensing circuit 321 is surrounded by the NFC antenna 311. The touch-sensing circuit 321 includes a first circuit connection element 322, which includes a number of pins.

FIG. 3(b) shows that the first PCB 30 further includes a transparent shielding layer 323. The transparent shielding layer 323 is arranged on a rear surface of the first PCB 30 opposite from the surface having the touch screen 20, and the transparent shielding layer 323 spatially corresponds to the peripheral area of the front surface to shield the NFC antenna 311 from electrostatic interference caused by electrical elements (not shown), which are mounted on a main circuit board (not shown) located under the first PCB 30.

The second PCB 40 is a flexible PCB, and FIGS. 1 and 2 show that the second PCB 40 is connected to the rear surface of the first PCB 30. The second PCB 40 is configured to electrically connect the first PCB 30 to the main circuit board of the electronic device 100.

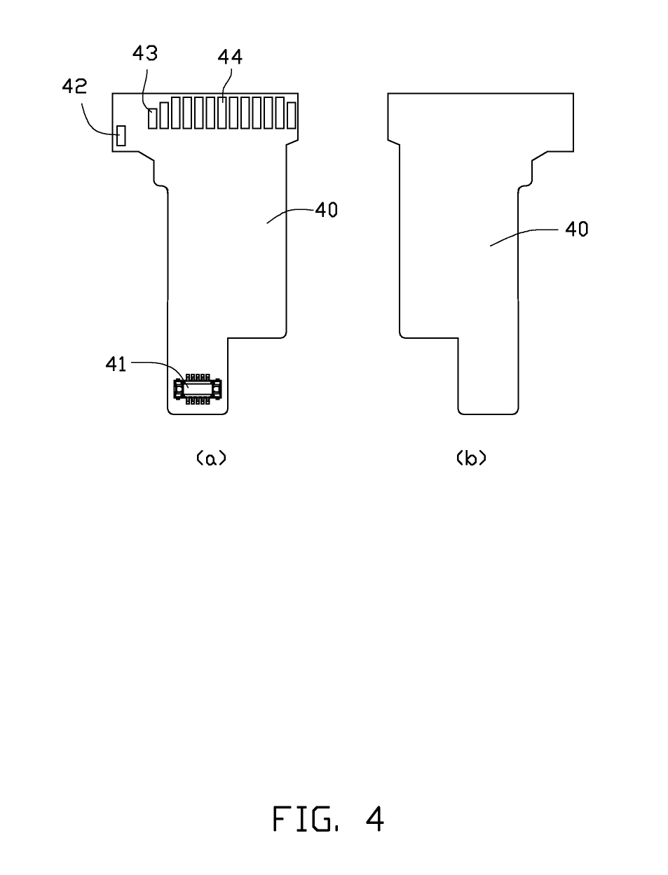

FIG. 4(a) shows that the second PCB 40 includes a first antenna connection pin 42, a second antenna connection pin 43, and a second circuit connection element 44. In one embodiment, the first antenna connection pin 42 and the second antenna connection pin 43 are electrically connected to the first antenna connection element 312 and the second antenna connection element 313, respectively. The second circuit connection element 44 includes a number of pins respectively electrically connected to the pins of the first circuit connection element 322.

A connector 41 is mounted on the second PCB 40 and is configured to electrically connect the second PCB 40 to the main circuit board of the electronic device 100. In one embodiment, the connector 41 includes a number of pins respectively electrically connected to the first antenna connection pin 42, the second antenna connection pin 43, and each pin of the second circuit connection element 44. Therefore, the NFC antenna 311 and the touch-sensing circuit 321 are both electrically connected to the main circuit board of the electronic device 100 through the connector 41.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A portable electronic device comprising:
a touch screen comprising an effective touch area and an ineffective touch area surrounding the effective touch area;
a first PCB mounted to a rear surface of the touch screen;
an NFC antenna and a touch-sensing circuit arranged side-by-side around a peripheral area of a front surface of the first PCB facing the touch screen and spatially corresponding to the ineffective touch area; and
a transparent shielding layer arranged on a rear surface of the first PCB and spatially corresponding to the peripheral area of the front surface to shield the NFC antenna from electrostatic interference caused by electrical elements located under the first PCB.

2. The electronic device as described in claim 1, wherein the NFC antenna comprises a coil surrounding the effective touch area to increase an effective space of the NFC antenna.

3. The electronic device as described in claim 2, wherein the touch-sensing circuit surrounds the effective touch area.

4. The electronic device as described in claim 3, wherein the touch-sensing circuit is surrounded by the NFC antenna.

5. The electronic device as described in claim 1, further comprising a second PCB connected to the rear surface of the first PCB to the touch screen, the second PCB configured to electrically connect the first PCB to a main circuit board of the electronic device.

6. The electronic device as described in claim 5, wherein the second PCB is a flexible PCB.

7. The electronic device as described in claim 5, wherein the NFC antenna further comprises a first antenna connection element and a second antenna connection element connected to two ends of the coil, respectively; the second PCB comprises a first antenna connection pin and a second antenna connection pin electrically connected to the first antenna connection element and the second antenna connection element, respectively.

8. The electronic device as described in claim 7, wherein the touch-sensing circuit comprises a first circuit connection element, which comprises a plurality of pins; the second PCB further comprises a second circuit connection element, wherein the second circuit connection element comprises a plurality of pins respectively electrically respectively connected to the pins of the first circuit connection element.

9. The electronic device as described in claim 8, further comprising a connector mounted on the second PCB and electrically connected to the main circuit board of the electronic device, wherein the connector comprises a plurality of pins respectively electrically connected to the first antenna connection pin, the second antenna connection pin, and each pin of the second circuit connection element.

10. The electronic device as described in claim 1, wherein the touch screen is made of carbon nanotubes.
